(19) United States
(12) Patent Application Publication
(10) Pub. No.: US 2015/0301247 A1
(43) Pub. Date: Oct. 22, 2015

(54) OPTICAL REFLECTION FILM, INFRARED SHIELDING FILM, AND PROCESS FOR PRODUCING THE SAME

(71) Applicant: KONICA MINOLTA, INC., Tokyo (JP)

(72) Inventor: Yasuo Taima, Tokyo (JP)

(73) Assignee: Konica Minolta, Inc., Tokyo (JP)

(21) Appl. No.: 14/440,180

(22) PCT Filed: Oct. 30, 2013
(86) PCT No.: PCT/JP2013/079360

§ 371 Date: May 1, 2015

(30) Foreign Application Priority Data
Nov. 2, 2012 (JP) 2012-242593

(51) Int. Cl. G02B 5/28; G02B 5/08

(52) U.S. Cl. CPC G02B 5/282; G02B 5/0816

(57) ABSTRACT

To provide an optical reflection film which has high reflectance of light with desired wavelength and reduced haze, by controlling the level of interlayer mingling to suppress the disturbances of the interface, even when the optical reflection film is produced by multilayer coating, in particular, by simultaneous multilayer coating which allows a high production efficiency.

Provided is an optical reflection film which has a base and, formed thereon, at least one unit obtained by laminating a high refractive index layer and a low refractive index layer, in which the low refractive index layer contains silica particles onto which a silanol-modified polyvinyl alcohol has been adsorbed.

### TECHNICAL FIELD

The present invention relates to an optical reflection film, an infrared shielding film, and a process for producing the same.

### BACKGROUND ART

Recently, as a glass used for buildings or a glass used for vehicles, a thermally insulating glass having an infrared shielding property is employed for the purpose of shielding solar radiation energy entering a room or a vehicle and lowering temperature increase and cooling load. Meanwhile, an infrared shielding film formed by laminating layers having different refractive indexes is conventionally known and a method of blocking transmission of heat rays among sunlight by attaching the infrared shielding film to a glass receives attention as a more convenient method.

With regard to an infrared shielding film, there is a method of producing a laminated film in which a high refractive index layer and a low refractive index layer are alternately laminated by a gas phase film forming method such as a vapor deposition method or a sputtering. However, there are problems in that the gas phase film forming method requires high production cost, and thus it is difficult to form a film with a large area and the method is limited to a heat resistant material.

As such, for producing an infrared shielding film, it is advantageous to use a liquid phase (wet) film forming method from the viewpoint of having low production cost, capable of increasing an area, and having a broad range of substrate selections (for example, see JP 2009-86659 A).

When a coating method is used among liquid phase film forming methods, as a method for producing a laminated film with at least two layers on a substrate by coating, there are successive coating in which lamination is performed by layer-by-layer coating and drying and simultaneous multilayer coating in which plural layers are coated simultaneously. Examples of the successive coating include a spin coating, a bar coating, a blade coating, and a gravure coating. However, for producing a multilayer film like an infrared reflection film, a large number of coating and drying is required, and thus the productivity is low. Meanwhile, examples of the simultaneous multilayer coating include a method using curtain coating, slide bead coating, or the like. Since multiple layers can be formed simultaneously, the productivity is high.

### SUMMARY OF INVENTION

### Technical Problem

However, the coating film obtained by multilayer coating tends to have more frequent occurrence of mingling in a space between adjacent layers or disturbances (irregularities) at an interface. In particular, since the coating film obtained by simultaneous multilayer coating is overlapped with each other in a non-dried liquid state, it is more likely to have an occurrence of mingling in a space between adjacent layers or disturbances (irregularities) at an interface. In a multilayer film like an infrared shielding film, interlayer mingling at suitable level exhibits a favorable effect on film adhesiveness or optical properties. However, as the interface disturbances increase, it becomes a cause of haze, and therefore undesirable. Furthermore, when multilayer coating is performed by using a coating liquid with conventional composition, a stripe pattern is generated or dotted defects during the coating occur, yielding a problem in coating property.

The present invention is devised under the circumstance described above, and an object of the present invention is to provide an optical reflection film and an infrared shielding film having excellent reflectance of light with desired wavelength and little haze by controlling the level of interlayer mingling to suppress disturbances at an interface, even when production is performed by multilayer coating, in particular, by simultaneous multilayer coating with high production efficiency.

The other object of the present invention is to provide a method for producing an optical reflection film and an infrared shielding film, in which coating stripes or dotted defects are reduced during coating even when simultaneous multilayer coating is performed, as the coating liquid has favorable stability and coating property.

### Solution to Problem

By adopting the following constitution, one object of the present invention is achieved.

That is, according to the present invention, there is provided an optical reflection film including a base and, formed thereon, at least one unit obtained by laminating a high refractive index layer and a low refractive index layer, wherein the low refractive index layer includes silica particles onto which a silanol-modified polyvinyl alcohol has been adsorbed.

Furthermore, by adopting the following constitution, one object of the present invention is achieved.

There is also provided a method for producing an optical reflection film, the method including: a step of producing a coating liquid for a low refractive index layer in which silica particles adsorbed with silanol-modified polyvinyl alcohol are contained; a step of producing a coating liquid for a high refractive index layer in which metal oxide particles are contained; and a step of alternately laminating on a substrate the coating liquid for a low refractive index layer and the coating liquid for a high refractive index layer by simultaneous multilayer coating.

### DESCRIPTION OF EMBODIMENTS

One embodiment of the present invention is, with regard to an infrared shielding film which includes a base and, formed thereon, at least one unit obtained by laminating a high refractive index layer and a low refractive index layer, an optical reflection film, in which the low refractive index layer contains silica microparticles onto which a silanol-modified polyvinyl alcohol has been adsorbed. Furthermore, one preferred embodiment of the present invention is, with regard to an infrared shielding film which includes a base and, formed thereon, at least one unit obtained by laminating a high refractive index layer and a low refractive index layer, an infrared shielding film, in which the low refractive index layer contains silica particles onto which a silanol-modified polyvinyl alcohol has been adsorbed.

With the constitution of the present invention, stability of a coating liquid and a property of coating a lower layer by a coating liquid are improved, and also interlayer mingling in a space between adjacent layers of a laminate obtained is suppressed. As such, an optical reflection film with high optical reflectance and high transparency is obtained.

The coating film obtained by multilayer coating tends to have an occurrence of mingling in a space between adjacent layers or disturbances (irregularities) at an interface. In the case of successive multilayer coating, the already-formed lower layer is dissolved again when a coating liquid for an upper layer is coated. As such, there is a case in which liquids of the upper layer and lower layer are mixed with each other and mingling in a space between adjacent layers or disturbances (irregularities) at an interface occur. Furthermore, since the coating film obtained by simultaneous multilayer coating is overlapped with each other in a non-dried liquid state, it is more likely to have occurrences of mingling in a space between adjacent layers or disturbances (irregularities) at an interface. When the interlayer mingling is excessively high, it causes a decrease in haze, and thus not desirable. Thus, it is necessary to keep the disturbances at an interface at low level.

It is now found that, by using, for a low refractive index layer, silica particles onto which a silanol-modified polyvinyl alcohol has been adsorbed, it is possible to obtain a film with low haze value and high transparency which is obtained by multilayer coating, in particular simultaneous multilayer coating. It is believed to be caused by suppressed interlayer mingling between an upper layer and a lower layer.

The mechanism for exhibiting the working effect which is obtained by the aforementioned constitution of the present invention is believed to be as follows.

By having silanol-modified polyvinyl alcohol adsorbed onto silica particles, the total particle diameter increases to suppress particle migration within a layer. Accordingly, it is believed that the interface mingling is suppressed between adjacent layers. It is also believed that, as a strong hydrogen bond network is formed between the silanol group of silanol-modified polyvinyl alcohol and the silica particles, migration of silica particles within a layer is suppressed to yield less interface mingling. It is also believed that, as interlayer mingling between the high refractive index layer and the low refractive index layer is suppressed, desirable optical shielding property (in particular, infrared shielding property) is achieved and haze is also improved. It is also believed that, when the low refractive index layer contains a water soluble polymer as a binder resin, migration of silica particles is further suppressed due to forming of a strong network between the polyvinyl alcohol in silanol-modified polyvinyl alcohol and water soluble polymer, and thus interface mingling between layers is further reduced.

It was also found that, by using silica microparticles adsorbed with silanol-modified polyvinyl alcohol for the low refractive index layer, stability of a coating liquid used for producing the low refractive index layer is improved, and thus a coating liquid can be coated homogeneously with less coating defects (for example, coating stripes or dotted defects) even when a film with large area is produced. It is believed that the effect of enhancing the stability of a coating liquid used for coating, and also improving an occurrence of defects during coating is obtained. It is believed that, by having less coating defects, the interface between adjacent layers becomes more homogeneous and haze is further reduced.

Meanwhile, the aforementioned mechanism is merely an assumption, and it is not intended to limit the scope of the present invention thereto.

Hereinbelow, constitution of the optical reflection film is described in detail.

In the present specification, the expression “X to Y” representing a range indicates “equal to or higher than X but equal to or lower than Y”. The terms “weight” and “mass”, “% by weight” and “% by mass”, and “parts by weight” and “parts by mass” are all regarded as synonyms. Furthermore, unless specifically described otherwise, operations and measurements of a physical property are performed at conditions of room temperature (20 to 25° C.)/relative humidity of 40 to 50%.

Meanwhile, in the present specification, the “infrared shielding film” indicates a film capable of shielding part or all of infrared ray by reflecting or absorbing infrared ray, preferably near infrared ray having the wavelength of about 700 nm to 2500 nm.

Furthermore, a refractive index layer having higher refractive index compared to other is referred to as a high refractive index layer and a refractive index layer having lower refractive index compared to other is referred to as a low refractive index layer. Thus, the terms “high refractive index layer” and “low refractive index layer” include, for two adjacent refractive index layers among each of the refractive index layers for constituting an optical reflection film, every mode except that a mode in which each refractive index layer has the same refractive index.

<Low Refractive Index Layer>

[Silica Particles Adsorbed with Silanol-Modified Polyvinyl Alcohol (Hereinbelow, Also Referred to as Adsorbed Silica Particles)]

The silica particles constituting the adsorbed silica particles have the average particle diameter of preferably 3 to 50 nm, more preferably 3 to 40 nm, even more preferably 3 to 20 nm, and particularly preferably 4 to 10 nm. It is preferable in that, by using silica particles within this range, an optical reflection film having low haze and excellent visible light transmission can be obtained. The average particle diameter of the silica particles indicates the volume average particle diameter which is measured by dynamic light scattering (instrument for measurement: Zetasizer Nano-S (manufactured by Malvern Instruments Ltd)) of silica particles that are not adsorbed with silanol-modified polyvinyl alcohol. The volume average particle diameter of silica particles in aqueous silica sol mentioned below can be measured in a dispersion state in the sol. Meanwhile, according to the measurement method based on dynamic light scattering, measurement is made regardless of primary or secondary particles. As such, the average particle diameter described herein indicates the average particle diameter of particles including primary particles, secondary particles, and their aggregates.

The silanol-modified polyvinyl alcohol for constituting adsorbed silica particles is not particularly limited. It may be the one synthesized by a known method or a commercially available product. The polymerization degree of the silanol-modified polyvinyl alcohol is generally 300 to 2,500, and preferably 500 to 1,700. When the polymerization degree is 300 or higher, the coating layer has high strength, and when it is 2,500 or lower, viscosity of the coating liquid is not excessively high, yielding process suitability, and therefore desirable. The deformation ratio of the silanol-modified polyvinyl alcohol is generally 0.01 to 5% by mol, and preferably 0.1 to 1% by mol. When the deformation ratio is less than 0.01% by mol, the water resistance may be deteriorated. On the other hand, when it is more than 5% by mol, solubility with water may be lowered. In particular, from the viewpoint of scratch resistance and gloss trace, silanol-modified polyvinyl alcohol having the saponification degree of preferably 95% by mol or more and more preferably 95.0 to 99.5% by mol is preferable. The silanol-modified polyvinyl alcohol used for adsorption may be either one type or in combination of two or more types.

Adsorption of silanol-modified polyvinyl alcohol on silica particles can be determined easily by measuring an average particle diameter. Specifically, if the average particle diameter is found to be increased when comparison of the average particle diameter is made between silica particles adsorbed with silanol-modified polyvinyl alcohol and silica particles not adsorbed with silanol-modified polyvinyl alcohol, it can be confirmed that silanol-modified polyvinyl alcohol is adsorbed onto the silica particles.

Meanwhile, the adsorption described herein means a state in which at least part of the surface of silica particles is adsorbed with silanol-modified polyvinyl alcohol. Namely, the surface of silica particles may be completely coated with silanol-modified polyvinyl alcohol, or only part of the surface of silica particles may be coated with silanol-modified polyvinyl alcohol.

The average particle diameter of silica particles adsorbed with silanol-modified polyvinyl alcohol is preferably 2 to 30 times, and preferably 3 to 16 times the average particle diameter of the silica particles not adsorbed with silanol-modified polyvinyl alcohol.

As described above, it is preferable to use nano particles of 3 to 50 nm or so as silica particles from the viewpoint of visible light transmission and haze. As such, the average particle diameter of silica particles adsorbed with silanol-modified polyvinyl alcohol is preferably 20 to 80 nm. When the average particle diameter of the adsorbed silica particles is 20 nm or more, suitable adsorption of silanol-modified polyvinyl alcohol is obtained to reduce the haze value. Accordingly, not only the film properties are improved but also coating defects like coating stripes and dotted defects are further reduced. Furthermore, when the average particle diameter of adsorbed silica particles is 80 nm or less, the visible light transmission is enhanced and it is not likely to have gellation of a coating liquid. The average particle diameter indicates volume average particle diameter which is measured by dynamic light scattering of dispersion solution of silica particles that are adsorbed with silanol-modified polyvinyl alcohol (instrument for measurement: Zetasizer Nano-S (manufactured by Malvern Instruments Ltd)). Dispersion medium for dispersion solution for measuring particle diameter is aqueous dispersion medium, preferably water, and the sample concentration is 2 to 10% by weight (solid content). Furthermore, the dispersion solution for measuring the average particle diameter is measured at 25° C.

Silica particles adsorbed with silanol-modified polyvinyl alcohol are preferably formed by mixing and heating aqueous silica sol and a solution of silanol-modified polyvinyl alcohol. The silica particles obtained as such are preferable in that the silanol-modified polyvinyl alcohol is stably in an adsorbed state.

Aqueous silica sol is not particularly limited, and it may be the one synthesized by a known method or a commercially available product. Meanwhile, the aqueous silica sol indicates colloidal silica having silica particles dispersed in an aqueous dispersion medium (it is also referred to as colloid silica or colloid silicic acid). As described herein, the aqueous dispersion medium indicates a dispersion medium which contains water at 80% by weight or more, preferably 95% by weight or more, and more preferably 100% by weight. Examples of a component other than water which can be contained in the aqueous dispersion medium include lower alcohol with 1 to 3 carbon atoms, alcohols such as 2-propanol or 1-butanol, esters such as ethyl acetate, butyl acetate, propylene glycol monomethyl ether acetate, and propylene glycol monoethyl ether acetate, ethers such as diethyl ether, propylene glycol monomethyl ether, or ethylene glycol monoethyl ether, amides such as dimethyl formamide or N-methyl pyrrolidone, and ketones such as acetone, methyl ethyl ketone, acetyl acetone, or cyclohexanone. It is preferably lower alcohol.

Representative examples of a method for preparing aqueous silica sol include a method of using, as a raw material, alkali metal silicate such as potassium silicate or sodium silicate and a method of hydrolyzing alkoxysilane such as tetramethoxyl silane or tetraethoxy silane. Examples include those described in JP 57-14091 A, JP 60-219083 A, JP 60-219084 A, JP 61-20792 A, JP 61-188183 A, JP 63-17807 A, JP 4-93284 A, JP 5-278324 A, JP 6-92011 A, JP 6-183134 A, JP 6-297830 A, JP 7-81214 A, JP 7-101142 A, JP 7-179029 A, JP 7-137431 A, and WO 94/26530 A.

When alkali metal salt of silicic acid like sodium silicate is used as a raw material for preparing aqueous silica sol, mention can be made of metathesis using acid like hydrochloric acid and sulfuric acid and a method of replacing an alkali metal atom in alkali metal salt of silicic acid with a hydrogen atom by using a cation exchange resin having hydrogen ion (H⁺) as a counter ion. With regard to a method of preparing silica sol by the metathesis using acid or the like, mention can be made of a method in which an aqueous solution of alkali metal salt of silicic acid is added to an aqueous acid solution while stirring the acid solution and a method of contacting and mixing an aqueous acid solution and an aqueous solution of alkali metal salt of silicic acid in a pipe (see, JP H4-54619 B, for example). The method of preparing silica sol by using acid type cation exchange resin can be also performed by using a known method. For example, there are methods as follows: a method in which an aqueous solution of alkali metal salt of silicic acid at suitable concentration is passed through a filling layer which has been filled with an acid type cation exchange resin, and a method of adding and mixing an acid type cation exchange resin to an aqueous solution of alkali metal salt of silicic acid and separating the acid type cation exchange resin by performing filtration, separation, or the like after removing the alkali metal ions by chemical adsorption onto the cation exchange resin. At that time, it is necessary that the amount of acid type cation exchange resin to be used is higher than the amount allowing exchange of alkali metal contained in the solution. Any known acid type cation exchange resin can be used without any particular limitation. Examples thereof include an ion exchange resin like styrene-based, acryl-based and methcryl-based, and those having a sulfonate group or carboxylate group as an ion exchange group can be used. Among them, a so-called strong acid type cation exchange resin having a sulfonate group can be preferably used.

As for the aqueous silica sol, a commercially available product may be used. Examples of the commercially available product include SNOWTEX series (SNOWTEX 20, SNOWTEX 30, SNOWTEX 40, SNOWTEX O, SNOWTEX OS, SNOWTEX OXS, SNOWTEX XS, SNOWTEX O-40, SNOWTEX C, SNOWTEX N, SNOWTEX S, SNOWTEX 20L, SNOWTEX OL) that are provided by Nissan Chemical Industries, Ltd.

A solvent for preparing a solution of the silanol-modified polyvinyl alcohol is preferably, although not particularly limited, water, an organic solvent, or a mixture solvent thereof. From the environmental point of view regarding to scattering of an organic solvent, water, or a mixture solvent containing water and a small amount of organic solvent is more preferable. Water is particularly preferable.

Examples of the organic solvent include alcohols such as methanol, ethanol, 2-propanol, or 1-butanol, esters such as ethyl acetate, butyl acetate, propylene glycol monomethyl ether acetate, and propylene glycol monoethyl ether acetate, ethers such as diethyl ether, propylene glycol monomethyl ether, or ethylene glycol monoethyl ether, amides such as dimethyl formamide or N-methyl pyrrolidone, and ketones such as acetone, methyl ethyl ketone, acetyl acetone, or cyclohexanone. These organic solvents may be used either singly or in combination of two or more types. From the environmental point of view and easy handling, in particular, water, or a mixture solvent of water and methanol, ethanol, or ethyl acetate is preferable as a solvent for the coating liquid. Water is more preferable.

When a mixture containing water and a small amount of organic solvent is used, the water content in the mixture solvent is preferably 80 to 99.9% by weight, and more preferably 90 to 99.5% by weight when the entire mixture solvent is 100% by weight. When it is 80% by weight or more, a volume change caused by solvent evaporation can be reduced so that the handling property is improved. Further, when it is 99.9% by weight or less, the homogeneity is enhanced at the time of liquid addition so that a stable liquid property can be obtained.

The silanol-modified polyvinyl alcohol solution may contain only one type of silanol-modified polyvinyl alcohol or two or more types of silanol-modified polyvinyl alcohol.

The concentration of the silanol-modified polyvinyl alcohol in a silanol-modified polyvinyl alcohol solution is, from the viewpoint of workability, solubility, and stability of a solution, preferably 2 to 10% by weight relative to the total solution amount.

The mixing ratio for mixing aqueous silica sol and a silanol-modified polyvinyl alcohol is preferably, in terms of solid content weight ratio of silica to silanol-modified polyvinyl alcohol, silica:silanol-modified polyvinyl alcohol=2 to 20:1, and more preferably 10 to 15:1. When mixing is performed within this range, the adsorption of the silanol-modified polyvinyl alcohol on silica particles tends to progress at a favorable level.

After mixing aqueous silica sol and a silanol-modified polyvinyl alcohol solution, a heating treatment is performed. According to the heating treatment, molecules of silanol-modified polyvinyl alcohol are adsorbed onto the silica particles. The heating conditions at that time are not particularly limited as they are suitably set to allow appropriate adsorption. As a preferred embodiment, the heating temperature is preferably 30 to 70° C., and more preferably 40 to 60° C. At this temperature conditions, adsorption is suitably achieved and aggregation among particles is suppressed, and therefore desirable. Furthermore, the heating time is preferably 30 to 300 minutes, and more preferably 60 to 180 minutes.

The content of silanol-modified polyvinyl alcohol adsorbed silica particles in the low refractive index layer is, relative to the total solid content 100% by weight of the low refractive index layer, preferably 15 to 85% by weight, more preferably 20 to 80% by weight, and even more preferably 30 to 75% by weight. When it is within the above range, a favorable optical reflection property (infrared shielding property, in particular) can be obtained.

The low refractive index layer may contain, if necessary, metal oxide particles other than the adsorbed silica particles (for example, silica particles), a binder resin, a curing agent, a surfactant, and various additives. The binder resin, curing agent, surfactant, and various additives will be described below.

<High Refractive Index Layer>

The high refractive index layer is not particularly limited, if it is a layer having higher refractive index than the low refractive index layer. However, as the refractive index can be easily controlled, it is preferable for the high refractive index layer to contain metal oxide particles. Herein, since the metal oxide particles contained in the high refractive index layer cause a difference in refractive index, they are preferably metal oxide particles that are different from those of the low refractive index layer.

Examples of the metal oxide particles that are used in the high refractive index layer include titanium oxide, zirconium oxide, zinc oxide, alumina, colloidal alumina, niobium oxide, europium oxide, and zircon. For adjusting the refractive index, these metal oxides may be used either singly or in combination of two or more types.

To form the high refractive index layer with transparency and higher refractive index, it is preferable that the high refractive index layer contain titanium oxide or zirconium oxide which has high refractive index. Namely, according to one preferred embodiment of the present invention, the high refractive index layer contains at least one of titanium oxide and zirconium oxide. From the viewpoint of further enhancing the infrared reflectivity, the high refractive index layer preferably contains at least titanium oxide. It is more preferable to contain rutile type (quadratic type) titanium oxide particles having the volume average particle diameter of 100 nm or less. Furthermore, several kinds of titanium oxide particles may be mixed.

Furthermore, metal oxide particles contained in the low refractive index layer and metal oxide particles contained in the high refractive index layer may be prepared to have the same ionic property (that is, same electric charge polarity). That is since, when simultaneous multilayer coating is performed while having a different ionic property, for example, a reaction occurs at an interface to yield aggregates and poor haze. As a means for having the same ionic property, anionization of titanium oxide by treating with hydrated silicon-containing oxide or the like can be performed as described below.

The metal oxide particles contained in the high refractive index layer have the average particle diameter (number average) of preferably 3 to 100 nm and more preferably 3 to 50 nm. Herein, the average particle diameter (number average) is obtained by observing particles themselves or particles appeared on the cross section or surface of a refractive index layer with an electron microscope, measuring the particle diameters of 1,000 arbitrary particles, and calculating as a simple average value thereof (number average). Herein, the particle diameter of each particle is expressed as a diameter when assuming a circle corresponding to the projected area.

The content of the metal oxide particles in the high refractive index layer is, relative to the total solid content 100% by weight of the high refractive index layer, preferably 15 to 85% by weight, more preferably 20 to 80% by weight, and even more preferably 30 to 75% by weight. When it is within the above range, a favorable optical reflection property (infrared shielding property, in particular) can be obtained.

As titanium oxide particles, it is preferable to use those obtained by modifying a surface of aqueous titanium oxide sol to be dispersible in an organic solvent or the like.

Regarding the method for producing aqueous titanium oxide sol, it is possible to refer to the descriptions of JP 63-17221 A, JP 7-819 A, JP 9-165218 A, JP 11-43327 A, JP 63-17221 A, or the like for example.

In addition, as another method for producing titanium oxide particles when titanium oxide particles are used as metal oxide particles, it is possible to refer to, for example, “Titanium dioxide—physical property and applied technology” Manabu Seino, p. 255 to 258 (year 2000), Gihodo Shuppan Co., Ltd., or a method of process (2) described in paragraphs [0011] to [0023] of a specification of WO 2007/039953.

A production method according to process (2) includes process (2) that treats an obtained titanium dioxide dispersion with a compound containing a carboxylic acid group and an inorganic acid after process (1) that treats a titanium dioxide hydrate with at least one basic compound selected from the group consisting of a hydroxide of alkali metal and a hydroxide of an alkali earth metal.

It is preferable that the metal oxide particles contained in the high refractive index layer have core-shell particle form in which titanium oxide particles are coated with hydrated silicon-containing oxide. The core-shell structure indicates a structure in which the volume average particle diameter of titanium oxide particles as a core part is preferably more than 1 nm and less than 40 nm, and more preferably 4 nm or more and less than 40 nm, and a surface of titanium oxide particles is coated with a shell consisting of hydrated silicon-containing oxide such that the coating amount of hydrated silicon-containing oxide is 3 to 30% by weight in terms of SiO₂ compared to 100% by weight of titanium oxide as core. By containing core-shell particles, an effect of suppressing interlayer mingling between the high refractive index layer and low refractive index layer, which is caused by an interaction between the hydrated silicon-containing oxide in shell layer and a binder resin, is exhibited. Meanwhile, the volume average particle diameter of the titanium oxide particles refers to a weighted average particle diameter using a volume expressed by a volume average particle diameter mv={Σ(vi·di)}/{Σ(vi)} by using a method in which the particle itself is measured by laser diffraction scattering, dynamic light scattering, or by using an electron microscope or a method in which a particle image present on a cross-sectional surface or a surface of a refractive index layer is observed by an electron microscope, particle diameters of 1,000 arbitrary particles are measured, and a volume of a particle is set to vi in a group of particulate metal oxide including n1, n2, . . . , ni, . . . , nk particles having a particle diameter of d1, d2, . . . , di, . . . , dk, respectively. Further, it is preferable that titanium oxide particles correspond to a monodisperse. The term “monodisperse” described herein indicates that a monodispersity obtained by an equation below is 40% or less. The particles have a monodispersity of more preferably 30% or less, or particularly preferably 0.1 to 20%.

Monodispersity (%)=(Standard deviation of particle diameter)/(Average of particle diameter)×100 [Equation 1]

As described herein, the hydrated silicon-containing oxide can be any one of hydrate of inorganic silicon compound, a hydrolyzate and/or condensate of an organic silicon compound. To have the effect of the present invention, it preferably has a silanol group. Thus, in the present invention, the metal oxide particles contained in the high refractive index layer are preferably silica modified (silanol modified) titanium oxide particles, that is, titanium oxide particles modified with silica.

The coating amount of silicon-containing and hydrated compound of titanium oxide is, relative to 100% by weight of titanium oxide, 3 to 30% by weight, preferably 3 to 10% by weight, and more preferably 3 to 8% by weight. That is since, when the coating amount is 30% by weight or less, desired refractive index of the high refractive index layer is obtained, and when the coating amount is 3% or more, the particles can be stably formed.

Further, as the metal oxide particles contained in the high refractive index layer, core-shell particles that are produced by a known method can be also used. For example, there can be core-shell particles that are produced by the following methods (i) to (iv); (i) a method in which an aqueous solution containing titanium oxide particles is hydrolyzed by heating or alkali is added to an aqueous solution containing titanium oxide particles for neutralization to form fine titanium dioxide particles having 1 to 30 nm average particle diameter, the titanium oxide particles are mixed with a mineral acid in a molar ratio range of from 1/0.5 to 1/2 and the resultant slurry is heated at a temperature between 50° C. and the boiling point of the slurry, a silicon compound (for example, an aqueous, solution of sodium silicate) is added to a slurry containing the obtained titanium oxide particles for surface-treatment according to precipitation of hydrous silicon oxide on a surface of the titanium oxide particles, and impurities are removed from the slurry of the surface-treated titanium dioxide particles (JP 10-158015 A); (ii) a method in which titanium oxide sol which is obtained by peptizing of titanium oxide like hydrous titanium oxide with monobasic acid or a salt thereof and stable in an acidic pH range is admixed with alkyl silicate as a dispersion stabilizer by a general method followed by neutralization (JP 2000-053421 A); (iii) a method in which hydrogen peroxide and metal tin are simultaneously or alternately added to an aqueous solution of titanium salt (for example, titanium tetrachloride) mixture while maintaining the H2O2/Sn molar ratio at 2 to 3 to produce a basic aqueous salt solution containing titanium, the basic aqueous salt solution is maintained at a temperature of 50 to 100° C. for 0.1 to 100 hours to form an aggregate of composite colloid containing titanium oxide, and subsequently, by removing electrolytes in the aggregate slurry, stable aqueous sol of composite colloid particles containing titanium oxide is produced; an aqueous solution containing silicate (for example, an aqueous solution of sodium silicate) is prepared, and by removing cations that are present in the aqueous solution, a stable aqueous sol of composite colloid particles containing titanium dioxide is produced; the obtained aqueous composite sol containing titanium oxide is admixed with, in an amount of 100 parts by weight in terms of metal oxide TiO₂, the obtained aqueous composite sol containing silicon dioxide, in an amount of 2 to 100 parts by weight in terms of the metal oxide SiO₂, and heated and aged, after removing anions, for 1 hour at 80° C. (JP 2000-063119 A); (iv) a method in which hydrous titanic acid is dissolved by adding hydrogen peroxide to a gel or a sol of hydrous titanic acid, a silicon compound or the like is added to an aqueous solution of obtained peroxotitanic acid followed by heating to obtain a dispersion of core particles composed of composite solid solution oxide having a rutile type structure, a silicon compound or the like is added to a dispersion of the core particles, and a coating layer is formed on a surface of the core particles by heating to obtain a sol in which composite oxide particles are dispersed followed by heating (JP 2000-204301 A); and (v) a method in which a compound selected from organoalkoxysilane (R¹nSiX₄₋ₙ), hydrogen peroxide, and aliphatic or aromatic hydroxycarboxylic acid as a stabilizer is added to hydrosol of titanium oxide obtained by peptizing hydrous titanium oxide, pH of the solution is adjusted to 3 or higher and lower than 9 for aging, and a de-salting is performed (JP 4550753 A).

The core-shell particles may be those obtained by coating the entire surface of titanium oxide particles as a core with hydrated silicon-containing oxide or those obtained by coating a part of titanium oxide particles as a core with hydrated silicon-containing oxide.

The high refractive index layer may contain, if necessary, a binder resin, a curing agent, a surfactant, and various additives.

Hereinbelow, descriptions are given for the binder resin, curing agent, surfactant, and various additives that are optionally contained in the low refractive index layer and high refractive index layer.

[Binder Resin]

As described herein, the binder resin means, as a dispersion medium for dispersion subject like metal oxide particles, a polymer compound having weight average molecular weight of 1,000 to 200,000 (preferably 3,000 to 60,000). As described herein, the weight average molecular weight can be measured by a known method. For example, the measurement can be made by static light scattering, gel permeation chromatography (GPC), TOFMASS, or the like. By containing a binder resin, wet coating becomes possible so that the productivity can be enhanced.

The binder resin is contained preferably in the range of from 5% by weight to 75% by weight relative to 100% by weight of solid content in the refractive index layer. It is more preferably contained in the range of from 10% by weight to 70% by weight. However, when an emulsion resin is used in combination, for example, it can be contained at 3% by weight or more. When the binder resin is small, a tendency of having poor transparency due to disturbed film surface increases during drying after coating of a refractive index layer. Meanwhile, when the content is 75% by weight or less, the relative metal oxide content becomes appropriate so that it becomes easier to have a large difference in refractive index between the high refractive index layer and low refractive index layer.

As a binder resin, it is preferable to contain a water soluble polymer. In particular, at least the low refractive index layer preferably contains a water soluble polymer as a binder resin. Thus, one preferred embodiment of the present invention is an optical reflection film in which the low refractive index layer contains a water soluble polymer. Since the water soluble polymer has favorable compatibility with silanol-modified polyvinyl alcohol adsorbed on silica particles, when a water soluble polymer is used as a binder resin, a stable coating liquid can be produced and multilayer coating, in particular simultaneous multilayer coating, can be easily performed.

Meanwhile, the water soluble polymer means, when it is dissolved in water at the concentration of 0.5% by weight at a temperature allowing maximum dissolution of the water soluble polymer, weight of the insolubles that are filtered and separated by filtering using a G2 glass filter (maximum pore size of 40 to 50 μm) is 50% by weight or less of the water soluble polymer which has been added.

Examples of the water soluble polymer include a polymer having a reactive functional group, gelatin, or thickening polysaccharides. The water soluble polymer can be used either singly, or in combination of two or more types. Further, a synthetic product or a commercially available product can be used as a water soluble polymer.

(Polymer Having Reactive Functional Group)

Examples of the polymer having a reactive functional group include polyvinyl alcohols, polyvinyl pyrrolidones, acrylic resins such as polyacrylic acid, an acrylic acid-acrylonitrile copolymer, a potassium acrylate-acrylonitrile copolymer, a vinyl acetate-acrylic ester copolymer, and an acrylic acid-acrylic ester copolymer, styrene acrylic acid resins such as a styrene-acrylic acid copolymer, a styrene-methacrylic acid copolymer, a styrene-methacrylic acid-acrylic ester copolymer, a styrene-α-methyl styrene-acrylic acid copolymer, and styrene-α-methyl styrene-acrylic acid-acrylic ester copolymer, vinyl acetate-based copolymers such as a styrene-sodium styrene sulfonate copolymer, a styrene-2-hydroxyethyl acrylate copolymer, a styrene-2-hydroxyethyl acrylate-potassium styrene sulfonate copolymer, a styrene-maleic acid copolymer, a styrene-anhydrous maleic acid copolymer, a vinyl naphthalene-acrylic acid copolymer, a vinyl naphthalene-maleic acid copolymer, a vinyl acetate-maleic ester copolymer, a vinyl acetate-crotonic acid copolymer, and a vinyl acetate-acrylic acid copolymer, and a salt thereof.

Among them, from the viewpoint of having less dotted defects by having stable coating liquid when it is used in combination with silanol-modified polyvinyl alcohol in the adsorbed silica particles and having improved optical reflection properties (in particular, infrared reflection property), polyvinyl alcohol is particularly preferably used as a binder resin. Hereinbelow, descriptions are given for polyvinyl alcohol.

The polyvinyl alcohol preferably used in the present invention includes various modified polyvinyl alcohol in addition to common polyvinyl alcohol obtained by hydrolysis of polyvinyl acetate.

As the polyvinyl alcohol obtained by hydrolyzing vinyl acetate, those having an average polymerization degree of 1,000 or more are preferably used, and those having an average polymerization degree of 1,500 to 5,000 are particularly preferably used. In addition, those having a saponification degree of 70 to 100% by mol are preferably used, and those having a saponification degree of 80 to 99.5% by mol are particularly preferably used.

Examples of the modified polyvinyl alcohol include cation-modified polyvinyl alcohol, anion-modified polyvinyl alcohol, nonion-modified polyvinyl alcohol, and vinyl alcohol-based polymer.

Examples of the anion-modified polyvinyl alcohol include a polyvinyl alcohol having an anionic group as described in JP 1-206088 A, a copolymer of vinyl alcohol and a vinyl compound having a water soluble group as described in JP 61-237681 and S63-307979 A, and a modified polyvinyl alcohol having a water soluble group as described in JP 7-285265.

In addition, examples of the nonion-modified polyvinyl alcohol include a polyvinyl alcohol derivative in which a polyalkylene oxide group is added to a part of vinyl alcohol as described in JP 7-9758 A, a block copolymer of a vinyl compound having a hydrophobic group and vinyl alcohol described in JP 8-25795 A, and the like, silanol-modified polyvinyl alcohol having a silanol group, and a reactive group-modified polyvinyl alcohol having a reactive group such as acetoacetyl group, carbonyl group, or a carboxy group.

As the cation-modified polyvinyl alcohol, a polyvinyl alcohol having a primary to tertiary amino group or a quaternary ammonium group in the main chain or side chain of the polyvinyl alcohol described above is exemplified as described in JP 61-10483 A, and it is obtained by saponification of a copolymer of an ethylenically unsaturated monomer having a cationic group and vinyl acetate.

Examples of the ethylenically unsaturated monomer having a cationic group include trimethyl-(2-acrylamide-2,2-dimethylethyl) ammonium chloride, trimethyl-(3-acrylamide-3,3-dimethylpropyl) ammonium chloride, N-vinylimidazole, N-vinyl-2-methylimidazole, N-(3-dimethylaminopropyl)methacrylamide, hydroxyethyl trimethyl ammonium chloride, trimethyl-(2-methacrylamidepropyl) ammonium chloride, N-(1,1-dimethyl-3-dimethylaminopropyl)acrylamide, and the like. Proportion of a monomer containing a cation-modified group in a cation-modified polyvinyl alcohol is 0.1 to 10% by mol, preferably 0.2 to 5% by mol with respect to vinyl acetate.

Examples of the vinyl alcohol-based polymer include EXCEVAL (trade name: manufactured by KURARAY Co., Ltd.) and Nichigo G-Polymer (trade name: manufactured by The Nippon Synthetic Chemical Industry Co., Ltd.).

Polyvinyl alcohols may be employed in combinations of two or more types being different in the degree of polymerization or in kinds of modifications.

(Gelatin)

As gelatin, gelatins that have been widely used in the field of photosensitive materials for silver halide photography can be used. More specifically, examples include, in addition to acid-treated gelatins and alkali-treated gelatins, enzyme-treated gelatins obtained by an enzyme treatment during gelatin production process, and derivatives thereof, that is, those having an amino group, an imino group, a hydroxyl group, or carboxy group as a functional group in the molecule and obtained by a treatment with a chemical agent capable of reacting with the functional group. General methods for producing gelatins are well known, and for example, the descriptions of T. H. James: The Theory of Photographic Process 4th. ed. 1977 (Macmillan) page 55, Picture Handbook of Science (first volume), pages 72 to 75 (Maruzen), Basis for Photographic Engineering—Silver Halide Photography, pages 119 to 124 (Corona Publishing Co., Ltd.) and the like can be referred to. Furthermore, the gelatins described on page IX of Research Disclosure, Vol. 176, No. 17643 (December 1978) can also be exemplified.

Film Hardening Agent for Gelatin

When gelatin is used, it is also possible to add a hardening agent for gelatin, if necessary.

As a hardening agent which can be used, a known compound used as a hardening agent for common photographic emulsion layer can be used. Examples include an organic film hardening agent such as a vinyl sulfone compound, a urea-formalin condensate, a melanine-formalin condensate, an epoxy compound, an aziridine compound, active olefins, or an isocyanate compound and inorganic polyvalent metal salts like chrome, aluminum, and zirconium.

(Celluloses)

As celluloses, water soluble cellulose derivatives can be preferably used. Examples thereof include water soluble cellulose derivatives such as carboxylmethyl cellulose (cellulose carboxymethyl ether), methyl cellulose, hydroxymethyl cellulose, hydroxyethyl cellulose, or hydroxypropyl cellulose, and as celluloses containing carboxy group like carboxymethyl cellulose (cellulose carboxymethyl ether), and carboxyethyl cellulose. Other examples include cellulose derivatives such as nitrocellulose, cellulose acetate propionate, cellulose acetate, and cellulose sulfuric acid ester.

(Thickening Polysaccharides)

Thickening polysaccharides are not particularly limited, and examples include generally known natural simple polysaccharides, natural compound polysaccharides, synthetic simple polysaccharides, and synthetic compound polysaccharides. Referring to details of the polysaccharides, it is possible to refer to “Biochemistry encyclopedia (second edition), Tokyo chemistry coterie Publication”, “Food industry” 31st volume (1988) page 21, and the like.

The thickening polysaccharides are polymers of saccharides which have a large number of hydrogen bonding groups in the molecule, and are one of polysaccharides which has a property of having a large difference between the viscosity at a low temperature and the viscosity at a high temperature due to the hydrogen bonding strength difference between the molecules depending on temperature. Further, the thickening polysaccharides are polysaccharides having a viscosity increase property in which, when metal oxide fine particle is added to the polysaccharides, increase in the viscosity which is assumed to be due to the hydrogen bonding to the metal oxide fine particle is caused at a low temperature, and the viscosity increase due to the addition of the metal oxide fine particle at 15° C. is 1.0 mPa·s or higher, preferably 5.0 mPa·s or higher and more preferably 10.0 mPa·s or higher.

Examples of the thickening polysaccharides include galactan (for example, agarose, agaropectin), galactomannoglycan (for example, locust bean gum, guaran), xyloglucan (for example, tamarind gum), glucomanno glycan (for example, konjak mannan, wood-derived glucomannan, xanthane gum), galactoglucomanno glycan (for example, coniferous wood-derived glycan), arabinogalacto glycan (for example, soybean-derived glycan, microorganism-derived glycan), glucorhamno glycan (for example, gellan gum), glycosaminoglycan (for example, hyaluronic acid, keratan sulfate) and red algae-derived natural polymer polysaccharides such as alginic acid and alginate, agar, κ-carrageenan, λ-carrageenan, τ-carrageenan and furcellaran. From the viewpoint of not decreasing the dispersion stability of a metal oxide particle coexisting in a coating liquid, those not having, as a constitution unit, a carboxylic acid group or a sulfonic acid group are preferred. Preferred examples of such polysaccharides include pentose such as L-arabitose, D-ribose, 2-deoxyribose or D-xylose; polysaccharides composed of only hexose such as D-glucose, D-fructose, D-mannose, or D-galactose. Specifically, tamarind seed gum known to be xyloglucan whose principal chain is glucose and whose side chain is xylose; guar gum, cationized guar gum, hydroxypropyl guar gum, locust bean gum, tara gum known to be galacto mannan whose principal chain is mannose and whose side chain is galactose; and arabino galactan whose principal chain is galactose and whose side chain is arabinose are preferably used. In the present invention, tamarind, guar gum, cationized guar gum and hydroxypropyl guar gum are preferable.

[Curing Agent]

For curing the water soluble polymer, a curing agent can be used. The curing agent is not particularly limited as long as it can cause a curing reaction with the water soluble polymer. For example, in cases where polyvinyl alcohol is used, boric acids and salts thereof are preferred as a curing agent. Other known agents can be also used in addition to boric acids and salts thereof. In general, it is a compound having a group capable of reacting with polyvinyl alcohol or a compound capable of promoting a reaction between different groups of polyvinyl alcohol, and it is suitably selected and used. Specific examples thereof include epoxy-based curing agent (for example, diglycidyl ethyl ether, ethylene glycol diglycidyl ether, 1,4-butanediol diglycidyl ether, 1,6-diglycidyl cyclohexane, N,N-diglycidyl-4-glycidyloxyaniline, sorbitol polyglycidyl ether, glycerol polyglycidyl ether), aldehyde-based curing agent (for example, formaldehyde, glyoxal), active halogen based curing agent (for example, 2,4-dichloro-4-hydroxy-1,3,5-s-triazine), active vinyl-based compound (for example, 1,3,5-tris-acryloyl-hexahydro-s-triazine, bisvinylsulfonyl methyl ether), aluminum alum, and borax.

The boric acids or salts thereof mean oxyacids and salts thereof whose central atom is a boron atom. Specific examples thereof include orthoboric acid, diboric acid, metaboric acid, tetraboric acid, pentaboric acid and octaboric acid and salts thereof.

Boric acids and salts thereof containing a boron atom as a curing agent may be used as a sole aqueous solution, or two or more types thereof may be mixed and used. Particularly preferred is a mixed aqueous solution of boric acid and borax.

Although an aqueous solution of boric acid and borax can be added only in a relatively dilute aqueous solution, a concentrated aqueous solution can be obtained by mixing both the aqueous solutions, thereby concentrating the coating liquid. This also has an advantage of relatively freely controlling the pH of the aqueous solution added.

It is preferable to use, as a curing agent, at least one of boric acids and salts thereof and borax. When at least one of boric acids and salts thereof and borax is used, a hydrogen bond network between the metal oxide particles and OH group of polyvinyl alcohol as a water soluble polymer can be easily formed. As a result, it is believed that the interlayer mingling between the high refractive index layer and the low refractive index layer is suppressed and preferable optical reflection property is achieved. In particular, for a case of using a set-based coating process in which multilayers of the high refractive index layer and low refractive index layer are coated by using a coater, the surface temperature of coating film is cooled to 15° C., and the coating surface is dried, the effect can be more preferably exhibited.

The content of the curing agent in the refractive index layer is preferably 1 to 10% by weight and more preferably 2 to 6% by weight relative to 100% by weight of the solid content of the refractive index layer.

When polyvinyl alcohol is used as a water soluble polymer, in particular, the total use amount of curing agent is preferably 1 to 600 mg per gram of the polyvinyl alcohol, and more preferably 100 to 600 mg per gram of the polyvinyl alcohol.

[Surfactant]

It is preferable that a surfactant is contained in each refractive index layer from the viewpoint of coating property.

As a surfactant used for adjusting the surface tension at the time of the coating, an anionic surfactant, a nonionic surfactant, an amphoteric surfactant, or the like may be used. Of these, an anionic surfactant is more preferable. Preferred examples of a compound include a compound containing a hydrophobic group having 8 to 30 carbon atoms and a sulfonic acid group or a salt thereof in one molecule.

Examples of the anionic surfactant which may be used herein include a surfactant selected from the group consisting of alkyl benzene sulfonate, alkyl naphthalene sulfonate, alkane or olefin sulfonate, alkyl sulfate, polyoxyethylene alkyl or alkyl aryl ether sulfate, alkyl phosphate, alkyl diphenyl ether disulfonate, ether carboxylate, alkyl sulfosuccinate, α-sulfo fatty acid ester, and fatty acid salt; a condensate of a higher fatty acid and an amino acid; and naphthenate. Examples of the anionic surfactant which is preferably used include a surfactant selected from the group consisting of alkyl benzene sulfonate (especially, linear alkyl benzene sulfonate), alkane or olefin sulfonate (especially, secondary alkane sulfonate and α-olefin sulfonate), alkyl sulfate, polyoxyethylene alkyl or alkyl aryl ether sulfate (especially, polyoxyethylene alkyl ether sulfate), alkyl phosphate (especially, monoalkyl phosphate), ether carboxylate, alkyl sulfosuccinate, α-sulfo fatty acid ester, and fatty acid salt. Alkyl sulfosuccinate is particularly preferable.

The content of the surfactant in each refractive index layer is preferably 0.001 to 0.03% by weight, and more preferably 0.005 to 0.015% by weight, when the total mass of the coating liquid in the refractive index layer is 100% by weight.

[Additives]

In each refractive index layer, various additives can be used if needed. In addition, the content of the additives in each refractive index layer is preferably 0 to 20% by weight with respect to 100% by weight of the solid content of the refractive index layer. Examples of the additives will be described below.

(Amino Acids with Isoelectric Point of 6.5 or Less)

When the amino acids with isoelectric point of 6.5 or less are contained, the dispersion property of the metal oxide particles in the high refractive index layer or low refractive index layer can be enhanced.

The amino acid described herein is a compound including an amino group and a carboxyl group in the same molecule and may be an amino acid of any types of α-, β-, γ- or the like. Although some amino acids have optical isomers, there is no difference in the present invention in the effect of the amino acid due to the existence of optical isomers, and any isomer can be used alone or in a racemic body.

For detail description of amino acids applicable to the present invention, see the description in “the Encyclopedia of Chemistry, vol. 1 (Kagaku Daijiten 1), an abridged edition, 1960, published by Kyoritsu Shuppan Co., Ltd”, pages 268 to 270.

Specifically preferred amino acids includes asparaginic acid, glutamic acid, glycine, and serine. Glycine and serine are particularly preferred.

A particular pH balances positive and negative charges in an amino acid molecule, yielding overall charge of 0, and such pH value corresponds to an isoelectric point of an amino acid. The isoelectric point of each amino acid may be measured by isoelectric focusing electrophoresis at low ionic strength.

[Emulsion Resin]

Each refractive index layer may further contain an emulsion resin. By containing an emulsion resin, film flexibility is increased so that processability like attachment on glass is improved.

The emulsion resin indicates a resin finely dispersed in an aqueous medium, for example, resin particles with an average particle diameter of 0.01 to 2.0 μm are dispersed in an emulsion state, and it is obtained by emulsion polymerization of an oil soluble monomer using a high molecular weight dispersion agent with a hydroxyl group. There is no basic difference exhibited in the polymer components of the emulsion resin obtained depending on the type of the dispersion agent used. Examples of the dispersion agent used for polymerization of an emulsion include a low molecular weight dispersion agent such as alkyl sulfonate, alkyl benzenesulfonate, diethylamine, ethylene diamine, and quaternary ammonium salt, and a high molecular weight agent such as polyoxyethylene nonyl phenyl ether, polyoxyethylene lauric acid ether, hydroxyethyl cellulose, or polyvinyl pyrrolidone. When emulsion polymerization is carried out using a high molecular weight dispersion agent having a hydroxyl group, it is believed that the hydroxyl groups are present at least on the surface of microparticles, and thus chemical and physical properties of the emulsion are different from those of an emulsion resin polymerized by using other dispersion agent.

A polymeric dispersion agent having a hydroxyl group is a dispersion agent of a high molecular weight having a weight average molecular weight of 10,000 or more and substituted with a hydroxyl group at a side chain or a terminal. Examples thereof include a dispersion agent in which 2-ethylhexyl acrylate is copolymerized with an acrylic polymer such as sodium polyacrylate or polyacrylamide, a polyether such as polyethylene glycol or polypropylene glycol, and a polyvinyl alcohol, and a polyvinyl alcohol is particularly preferable.

Examples of the polyvinyl alcohol used as a polymeric dispersion agent include a modified polyvinyl alcohol like a cation-modified polyvinyl alcohol, an anion-modified polyvinyl alcohol having an anionic group such as a carboxyl group, or a silyl-modified polyvinyl alcohol having a silyl group in addition to a common polyvinyl alcohol obtained by hydrolysis of polyvinyl acetate. As the average polymerization degree of a polyvinyl alcohol is high, the effect of suppressing the occurrence of cracks is great when forming an ink absorbing layer. However, when the average polymerization degree is 5,000 or less, the viscosity of an emulsion resin is not high and handling a polyvinyl alcohol at the time of production is easy. Therefore, the average polymerization degree of a polyvinyl alcohol is preferably 300 to 5,000, more preferably 1,500 to 5,000, and particularly preferably 3,000 to 4,500. The saponification degree of a polyvinyl alcohol is preferably 70 to 100% by mol, and more preferably 80 to 99.5% by mol.

As a resin to be emulsion polymerized with the polymeric dispersion agent, an ethylene monomer such as an acrylic ester, a methacrylic ester, a vinyl compound, or a styrene compound, and a homopolymer or copolymer of diene compounds such as butadiene and isoprene are exemplified. For example, an acrylic resin, a styrene-butadiene-based resin, and an ethylene-vinyl acetate-based resin and the like are exemplified.

[Other Additives]

Various additives can be added to each refractive index layer like those including an ultraviolet absorbing agent described in JP 57-74193 A, JP 57-87988 A, and JP 62-261476 A, a discoloration inhibitor described in JP 57-74192 A, JP 57-87989 A, JP 60-72785 A, JP 61-146591 A, JP 1-95091 A, and JP 3-13376 A, a fluorescent brightening agent, a pH regulator such as sulfuric acid, phosphoric acid, acetic acid, citric acid, sodium hydroxide, potassium hydroxide, and potassium carbonate, an antifoaming agent, a lubricant agent such as diethylene glycol, a preservative, an antistatic agent, and a matting agent described in JP 59-42993 A, JP 59-52689 A, JP 62-280069 A, JP 61-242871 A, and JP 4-219266 A.

<Substrate>

The thickness of the substrate as a support for an optical reflection film is preferably 5 to 200 μm, and more preferably 15 to 150 μm. The substrate according to the present invention may be those having two pieces stacked on each other, and in that case, they have the same or different type.

The substrate applied for an optical reflection film is not particularly limited, if it is transparent. It is possible to use various resin films including a polyolefin film (polyethylene, polypropylene, and the like), a polyester film (polyethylene terephthalate, polyethylene naphthalate, and the like), polyvinyl chloride, cellulose triacetate, and the like. It is preferable to use a polyester film. Although not particularly limited, it is preferable to use, as a polyester film (hereafter, referred to as polyester), polyester having a film forming property and including a dicarboxylic acid component and a diol component as a main component. Examples of the dicarboxylic acid component as a main component include terephthalic acid, isophthalic acid, phthalic acid, 2,6-naphthalenedicarboxylic acid, 2,7-naphthalenedicarboxylic acid, diphenyl sulfone dicarboxylic acid, diphenyl ether dicarboxylic acid, diphenyl ethane dicarboxylic acid, cyclohexane dicarboxylic acid, diphenyl dicarboxylic acid, diphenyl thioether dicarboxylic acid, diphenyl ketone dicarboxylic acid, phenyl indane dicarboxylic acid, and the like. In addition, examples of the diol component may include ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenol fluorene dihydroxyethyl ether, diethylene glycol, neopentyl glycol, hydroquinone, cyclohexane diol, and the like. Among types of polyester including these as a main component, it is preferable to use polyester including, as a main component, terephthalic acid or 2,6-naphthalenedicarboxylic acid as a dicarboxylic acid component, and including ethylene glycol or 1,4-cyclohexanedimethanol as a diol component in terms of transparency, mechanical strength, dimensional stability, and the like. Among them, it is preferable to use polyester including polythylene terephthalate or polyethylene naphthalate as a main component, copolyester containing terephthalic acid, 2,6-naphthalenedicarboxylic acid, and ethylene glycol, and polyester including a mixture of two or more types of polyester as a main component.

Further, the substrate preferably has a transmittance of a visible light region prescribed in JIS R3106-1998 of 85% or more, and particularly preferably 90% or more. By having the substrate with the same or greater transmittance than above, it is advantageous in that the transmittance of a visible light region prescribed in JIS R3106-1998 is 50% or more when it is prepared as an optical reflection film, and thus preferable.

Further, the substrate using the above resin or the like may be either a non-stretched film or a stretched film. From the viewpoints of improving strength and inhibiting thermal expansion, a stretched film is preferable.

The substrate can be produced by a known general method in the related art. For example, by melting a resin as a material using an extruder and extruding the resin using an annular die or a T die followed by rapid cooling, a non-stretched substrate which is substantially amorphous and not oriented can be produced. Further, a stretched substrate can be produced by stretching a non-stretched substrate in a flow (vertical axis) direction of the substrate or a direction perpendicular (horizontal axis) to the flow direction of the substrate by a known method such as monoaxial stretching, tenter type successive biaxial stretching, tenter type simultaneous biaxial stretching, or tubular type simultaneous biaxial stretching. For such a case, the stretching ratio can be suitably selected in accordance with the resin as a raw material of the substrate. However, the stretching ratio is preferably 2 to 10 times, in vertical axis direction and horizontal axis direction, respectively.

Further, from the viewpoint of dimensional stability, the substrate may be subjected to a relaxing treatment or an off-line heating treatment. After thermal fixing of the polyester film during stretching and film forming process, the relaxing treatment is preferably performed during a step within a tenter for horizontal stretching or winding after exit from the tenter. The relaxing treatment is preferably performed at a treatment temperature of 80 to 200° C. More preferably, the treatment temperature is 100 to 180° C. Moreover, the relaxing treatment is preferably performed in a range in which a relaxing rate is 0.1 to 10% both in the length direction and in the width direction. More preferably, the relaxing treatment is performed with a relaxing rate of 2 to 6%. The substrate after the relaxing treatment has favorable dimensional stability as well as improved heat resistance as a result of performing an off-line heating treatment which is described below.

A coating liquid for an undercoating layer is preferably in-line coated on one surface or both surfaces of the substrate during the film forming process. In the present invention, coating an undercoating during the film forming process is referred to as in-line undercoating. Examples of a resin used for the coating liquid for an undercoating layer include a polyester resin, an acryl modified polyester resin, a polyurethane resin, an acrylic resin, a vinyl resin, a vinylidene chloride resin, a polyethylene imine vinylidene resin, a polyethyleneimine resin, a polyvinyl alcohol resin, a modified polyvinyl alcohol resin, and gelatin, and any one of them can be preferably used. The undercoating layer may be added with known additives of the related art. Further, the undercoating layer may be coated by a well-known method such as roll coating, gravure coating, knife coating, dip coating, and spray coating. The coating amount of undercoating layer is preferably about 0.01 to 2 g/m² (in dry state).

<Functional Layer>

The optical reflection film may have, under the substrate or on top of the outermost layer on opposite side of the substrate, one or more of functional layer such as a conductive layer, an anti-static layer, a gas barrier layer, an easy adhesion layer (adhesive layer), an anti-fouling layer, a disinfecting layer, a droplet flowing layer, a lubricating layer, a hard coat layer, an anti-wearing layer, an anti-reflection layer, an electromagnetic wave shield layer, a ultraviolet absorbing layer, an infrared absorbing layer, a print layer, a fluorescence luminescent layer, a hologram layer, a release layer, a tacky layer, an adhesive layer, an infrared cut layer (a metal layer and a liquid crystal layer) other than the high refractive index layer and the low refractive index layer of the present invention, a colored layer (a layer for absorbing visible light), or an intermediate film layer used for laminated glass for the purpose of having additional functions.

In the optical reflection film, when various functional layers described above are included, the lamination order is not particularly limited.

For example, in a specification in which the optical reflection film of the present invention is pasted on the indoor side of window glasses (indoor pasting), an aspect where an optical interference film and a tacky layer are laminated on the substrate surface in this order, and a hard coat layer is formed by coating on the substrate surface opposite to the side on which the optical interference film and the tacky layer are laminated is exemplified as a preferred example. Moreover, the lamination order of the tacky layer, the substrate, the optical interference film, and the hard coat layer may be applicable, or other functional layers, the substrate, an infrared absorbing agent, or the like may be further included. In addition, in a specification in which the optical reflection film is pasted on the outdoor side of window glasses (outdoor pasting), a configuration in which an optical interference film and a tacky layer are laminated on the substrate surface in this order, and a hard coat layer is formed by coating on the substrate surface opposite to the side on which the optical interference film and the tacky layer are laminated is exemplified as a preferred example. Similar to the case of indoor pasting, the lamination order of the tacky layer, the substrate, the optical interference film, and the hard coat layer may be applicable, or other functional layers, an infrared absorbing agent, or the like may be further included.

<Film Design>

The optical reflection film of the present invention contains at least one unit of a high refractive index layer and a low refractive index layer, and preferably a multilayered optical interference film formed by alternately laminating a high refractive index layer and a low refractive index layer on one surface or both surfaces of the substrate. From the viewpoint of productivity, the total number of layers of the high refractive index layer and the low refractive index layer per one surface of the substrate is preferably in a range of 100 layers or less and 12 layers or more, and more preferably in a range of 45 layers or less and 15 layers or more. Further, the preferable range of the total number of layers of the high refractive index layer and the low refractive index layer is applicable to a case where layers are laminated on only one surface of the substrate and is also applicable to a case where layers are simultaneously laminated on both surfaces of the substrate. In a case where layers are laminated on both surfaces of the substrate, the total number of layers of the high refractive index layer and the low refractive index layer on one surface of the substrate and the total number thereof on the other surface of the substrate may be the same or different from each other. Moreover, in the optical reflection film, a lowermost layer (a layer which comes into contact with the substrate) and an outermost layer may be any one of the high refractive index layer and the low refractive index layer. However, by employing a layer configuration in which the low refractive index layers are located at the lowermost layer and the outermost layer, adhesiveness of the lowermost layer to the substrate, blowing resistance of the uppermost layer, and excellent coating property and adhesiveness of a hard coat layer to the outermost layer can be achieved. From the viewpoints of these, the optical reflection film preferably has a layer configuration in which the lowermost layer and the outermost layer are low refractive index layers.

In general, for the optical reflection film, it is preferable to design to have a large difference in refractive index between the high refractive index layer and the low refractive index layer from the viewpoint of the fact that the infrared reflectance can be increased with a small number of layers. In the present invention, the refractive index difference between the high refractive index layer and the low refractive index layer adjacent to each other is preferably 0.1 or more, more preferably 0.25 or more, even preferably 0.3 or more, further even preferably 0.35 or more, and most preferably 0.4 or more. Further, although not particularly limited, the upper limit is generally 1.4 or less.

The refractive index difference and required number of layers can be calculated by using a commercially available software for optical design. For example, in order to obtain the infrared reflectance of 90% or more, lamination of 200 or more layers is needed if the refractive index difference is less than 0.1, which yields not only lower productivity but also lower transparency due to higher scattering at lamination interface and in some cases, it is also very difficult to perform production without failures.

In a case where the optical reflection film is formed by alternately laminating the high refractive index layer and the low refractive index layer, it is preferable that the refractive index difference between the high refractive index layer and the low refractive index layer is within the above-described preferable range of the refractive index difference. However, for example, in a case where the outermost layer is formed as a layer for protecting a film or a case where the lowermost layer is formed as a layer for improving adhesiveness with respect to the substrate, the outermost layer or the lowermost layer may have a configuration in which the refractive index difference is out of the above-described preferable range.

A reflection on an adjacent interfacial layer is dependent on a refractive index ratio between layers. Thus, as the refractive index ratio increases, a reflectance increases. In addition, when an optical path difference of reflected light on a layer surface and reflected light on a bottom of a layer corresponds to a relation expressed by n·d=wavelength/4 as seen from a single layer film, it is possible to perform a control so that reflected light is strengthened by a phase difference, and a reflectance may be increased. Herein, n denotes a refractive index, d denotes a physical film thickness of a layer, and n·d denotes an optical film thickness (=path difference). When an optical path difference is used, a reflection may be controlled. A refractive index of each layer and a film thickness is controlled using the relation to control a reflection of visible light or near infrared light. That is, it is possible to enhance a reflectance of a specific wavelength region by a refractive index of each layer, a film thickness of each layer, and a laminating method of each layer.

The optical reflection film of the present invention may be set to a visible light reflection film or a near infrared reflection film by changing a specific wavelength region which enhances a reflectance. That is, it can be a visible light reflection film when a specific wavelength region which enhances a reflectance is set to a visible light region, or a near infrared reflection film when the specific wavelength region which enhances a reflectance is set to the near infrared region. It can be also an UV light reflection film when a specific wavelength region which enhances a reflectance is set to an UV right region. When the optical reflection film of the present invention is used as a heat barrier film, it may be a (near) infrared shielding (blocking) film. In the case of an infrared reflection film, it is preferable that a multilayer film in which films having different refractive indexes are laminated on a polymer film and the transmittance at 550 nm of a visible light region indicated by JIS R3106-1998 is 50% or more, more preferably 70% or more, and even preferably 75% or more. Furthermore, the transmittance at 1200 nm is preferably 35% or less, more preferably 25% or less, and even preferably 20% or less. It is desirable that an optical film thickness and a unit be designed to have them within those preferred ranges. Further, it is preferable to have a region which has a transmittance of more than 50% for the region of from 900 nm to 1400 nm.

Moreover, with regard to optical characteristics of the optical reflection film, a transmittance of the visible light region, prescribed in JIS R3106-1998, is 50% or more, preferably 75% or more, and more preferably 85% or more. Further, it is preferable to have a region with a reflectance of more than 50% in a region with a wavelength of 900 nm to 1,400 nm.

The refractive index of the low refractive index layer is preferably 1.10 to 1.60, and more preferably 1.30 to 1.50.

The refractive index of the high refractive index layer is preferably 1.80 to 2.50, and more preferably 1.90 to 2.20.

The thickness per layer of the each refractive index layer is preferably 20 to 800 nm, and more preferably 50 to 350 nm.

Herein, when the thickness per layer is measured, the high refractive index layer and the low refractive index layer may have a specific interface or a gradually changing interface therebetween. In a case where the interface gradually changes, respective layers are mixed. Therefore, when it is assumed that “maximum refractive index−minimum refractive index=Δn” in a region in which the refractive index continuously changes, the point of “minimum refractive index between two layers+Δn/2” is regarded as the interface between layers.

The metal oxide concentration profile in the laminated film, which is the optical interference film formed by alternately laminating the high refractive index layer and the low refractive index layer, can be observed by performing etching by using a sputtering method in the depth direction from the surface, performing the sputtering using an XPS surface analyzer while the outermost surface is 0 nm and the speed is 0.5 nm/min, and measuring an atomic composition ratio. Further, the metal oxide concentration profile may be observed by cutting the laminated film and measuring an atomic composition ratio of the cross-section using an XPS surface analyzer. In a case where the concentration of the metal oxide discontinuously changes in the mixed region, a boundary may be confirmed through a cross-sectional photograph by an electron microscope (transmission electron microscope; TEM).

With regard to an XPS surface analyzer, any type of an instrument can be used without particular limitation. However, ESCALAB-200R manufactured by VG Scientifics Co., Ltd. was used. Mg is used as an X ray anode and the measurement is made at an output of 600 W (an acceleration voltage of 15 kV and an emission electric current of 40 mA).

Herein, the total thickness of the optical reflection film is preferably 12 μm to 315 μm, more preferably 15 μm to 200 μm, and even more preferably 20 μm to 100 μm.

<Method for Producing Optical Reflection Film>

The production method of the optical reflection film is not particularly limited, but any method can be used as long as it is possible to form at least one unit consisting of a high refractive index layer and a low refractive index layer on a substrate.

In the production method of the optical reflection film, the optical reflection film is formed by laminating units consisting of the high refractive index layer and the low refractive index layer on the substrate. Specifically, it is preferable that the lamination be formed by simultaneous multilayer coating of the high refractive index layer and the low refractive index layer and then drying them. More specifically, one preferred embodiment of the present invention relates to an optical reflection film having a step of producing a coating liquid for a low refractive index layer in which silica particles adsorbed with silanol-modified polyvinyl alcohol are contained, a step of producing a coating liquid for a high refractive index layer in which metal oxide particles are contained, and a step of alternately laminating on a substrate the coating liquid for a low refractive index layer and the coating liquid for a high refractive index layer by simultaneous multilayer coating.

Another preferred embodiment of the present invention is an infrared reflection film having a step of producing a coating liquid for a low refractive index layer in which silica particles adsorbed with silanol-modified polyvinyl alcohol are contained, a step of producing a coating liquid for a high refractive index layer in which metal oxide particles are contained, and a step of alternately laminating on a substrate the coating liquid for a low refractive index layer and the coating liquid for a high refractive index layer by simultaneous multilayer coating.

(Step of Producing Coating Liquid for Low Refractive Index Layer in which Silica Particles Adsorbed with Silanol-Modified Polyvinyl Alcohol are Contained)

Silica particles adsorbed with silanol-modified polyvinyl alcohol are preferably obtained by mixing aqueous sol and a solution of silanol-modified polyvinyl alcohol followed by heating treatment as described above. At that time, the treatment conditions and the method for producing aqueous silica sol and silanol-modified polyvinyl alcohol are as described above.

For producing a coating liquid for a low refractive index layer, it is preferable to add a water soluble polymer as a preferred binder resin after obtaining the silica particles adsorbed with silanol-modified polyvinyl alcohol by the aforementioned heating treatment. Namely, according to one preferred embodiment of the present invention, the step for producing a coating liquid for a low refractive index layer includes the step (A) in which aqueous silica sol and a solution of silanol-modified polyvinyl alcohol are admixed with each other and heated to give silica particles adsorbed with silanol-modified polyvinyl alcohol, and the step (B) in which a water soluble polymer is added after the step (A). By adding a water soluble polymer after producing silica particles adsorbed with silanol-modified polyvinyl alcohol, adsorption of a water soluble polymer other than silanol-modified polyvinyl alcohol onto the silica particles is suppressed so as to have a state in which the silanol-modified polyvinyl alcohol is suitably adsorbed onto the silica particles.

The water soluble polymer is preferably used as a solution after being dissolved in a suitable solvent. The solvent is preferably water, an organic solvent, or a mixture solvent thereof, although it is not particularly limited thereto. Further, from the environmental point of view in relation to scattering of an organic solvent, water, or a mixture solvent containing water and a small amount of organic solvent is preferable. Water is particularly preferable. The content of an organic solvent and water in a mixture solvent is as defined in the above for describing the solvent for producing silanol-modified polyvinyl alcohol.

(Step of Producing Coating Liquid for High Refractive Index Layer in which Metal Oxide Particles are Contained)

The solvent for producing a high refractive index coating liquid is preferably water, an organic solvent, or a mixture solvent thereof, although it is not particularly limited thereto. Further, from the environmental point of view in relation to scattering of an organic solvent, water, or a mixture solvent containing water and a small amount of organic solvent is preferable. Water is particularly preferable. The content of an organic solvent and water in a mixture solvent, which are used in the invention, is as defined in the above for describing the solvent for producing silanol-modified polyvinyl alcohol.

The concentration of the binder resin in each coating liquid for the refractive index layer is preferably 1 to 10% by weight. Furthermore, concentration of the metal oxide particles in each coating liquid for refractive index layer is preferably 1 to 50% by weight.

The method for producing a coating liquid for a high refractive index layer and a coating liquid for a low refractive index layer is not particularly limited except the aforementioned preferred method for producing a coating liquid for a low refractive index layer. Examples thereof include a method in which metal oxide particles, a water soluble polymer, and other additives that are added if necessary, are added and mixed under stirring. In that case, the addition order of each component is not particularly limited, either. It is possible that each component is added and mixed in order under stirring, or all are added once and mixed under stirring. If necessary, by further using a solvent, it is prepared to have suitable viscosity.

(Method for Laminating Alternately on Substrate Coating Liquid for Low Refractive Index Layer and Coating Liquid for High Refractive Index Layer by Simultaneous Multilayer Coating)

As the coating method, a curtain coating method, or a slide bead coating method and an extrusion coating method or the like which uses a hopper as described in U.S. Pat. No. 2,761,419 and U.S. Pat. No. 2,761,791 is preferably used.

When performing the simultaneous multilayer coating, the temperature of the coating liquid for a high refractive index layer and the coating liquid for a low refractive index layer is preferably in a temperature range of 25 to 60° C., and more preferably 30 to 45° C. when a slide bead coating method is used. Moreover, when a curtain coating method is used, the temperature is preferably in a temperature range of 25 to 60° C., and more preferably 30 to 45° C.

When performing the simultaneous multilayer coating, the viscosity of the coating liquid for a high refractive index layer and the coating liquid for a low refractive index layer is not particularly limited. However, when a slide bead coating method is used, the viscosity is preferably in a range of 5 to 100 mPa·s, and more preferably 10 to 50 mPa·s in the above-described preferable temperature range of the coating liquid. Moreover, when a curtain coating method is used, the viscosity is preferably in a range of 5 to 1200 mPa·s, and more preferably in the range of 25 to 500 mPa·s in the above-described preferable temperature range of the coating liquid. When the viscosity is in the above range, simultaneous multilayer coating can be performed effectively.

Further, the viscosity at 15° C. of the coating liquid is preferably 100 mPa·s or more, more preferably 100 to 30,000 mPa·s, even more preferably 3,000 to 30,000 mPa·s, and most preferably 10,000 to 30,000 mPa·s.

(Coating and Drying Method)

The method for coating and drying is not particularly limited. In the case of successive coating, any one of a coating liquid for a high refractive index layer and a coating liquid for a low refractive index layer, both have been heated to 30 to 60° C., is coated and dried on a substrate to form a layer, and then, the other coating liquid is coated and dried on that layer to form a laminate film precursor (unit). Next, the units with a number required to exhibit desired optical reflection performance are subjected to successive coating and drying for lamination, and thus a laminate film precursor is obtained. For the drying, the formed coating film is preferably dried at a temperature of 30° C. or higher. Preferably, as a drying condition, a wet-bulb temperature is set to a range of 5 to 50° C., and a temperature of a film surface is set to a range of 5 to 100° C. (preferably, 10 to 50° C.). For example, hot air at 40 to 60° C. is blown for 1 to 5 seconds for drying. As for the drying method, hot air drying, infrared drying, or microwave drying is used. Drying by multi-step process is preferable than drying by single-step process, and it is more preferable that the temperature of an area be at constant drying rate<the temperature of an area at decreasing drying rate. In such case, it is preferable that the temperature range of an area at constant drying rate be 30 to 60° C. and the temperature range of an area at decreasing drying rate is 50 to 100° C.

With regard to the conditions for coating and drying method for performing the simultaneous multilayer coating, both a coating liquid for a high refractive index layer and a coating liquid for a low refractive index layer are heated to 30 to 60° C. and simultaneous multilayer coating of the coating liquid for a high refractive index layer and the coating liquid for a low refractive index layer is performed for a substrate, and then temporarily cool down a temperature of a formed coating film to 1 to 15° C. (setting), and perform a drying at 10° C. or higher. More preferably, as a drying condition, a wet-bulb temperature is set to a range of 5 to 50° C., and a temperature of a film surface is set to a range of 10 to 50° C. For example, hot air at 80° C. is blown for 1 to 5 seconds for drying. In addition, from the viewpoint of a uniformity of a formed coating film, it is preferable to perform a horizontal set scheme as a cooling scheme immediately after a coating.

“Setting” herein means a process in which, for example by means of decreasing the temperature of a film by blowing a cool air or the like on the film, the viscosity of a film composition is increased to lower the fluidity of materials between the layers and in each layer, and it also means a process of gellation. Specifically, the complete setting state is defined as a state in which, when cool air is blown to the surface of a coated film, nothing sticks to a finger when the finger is pressed against the surface.

The time from the coating to completing the setting by blowing cool air (setting time) is preferably 5 minutes or less. It is more preferably 2 minutes or less. Although the lower time limit is not particularly limited, it is preferable to have time of 45 seconds or more. When the setting time is excessively short, mixing of the components in the layer may become insufficient. On the other hand, when the setting time is excessively long, the interlayer diffusion of metal oxide particles progresses so that the refractive index difference between a high refractive index layer and a low refractive index layer may become insufficient. Meanwhile, when the high viscosity is quickly obtained for an intermediate layer between a high refractive index layer and a low refractive index layer, a step for setting may not be included.

The adjustment of setting time can be carried out by adjusting the concentration of a water soluble resin or the concentration of metal oxide particles, or by adding other components including various known gelleation agents like gelatin, pectin, agar, carrageenan, and gellan gum.

Temperature of the cool air is preferably 0 to 25° C., and more preferably 5 to 10° C. Furthermore, the time during which the coating film is exposed to cool air is, although it may vary depending on the return rate of coating film, preferably 10 to 360 seconds, more preferably 10 to 300 seconds, and even more preferably 10 to 120 seconds.

With regard to the coating thickness of a coating liquid for a high refractive index layer and a coating liquid for a low refractive index layer, the coating can be made so as to have the desired dry thickness as described above.

<Optical Reflection Body>

The optical reflection film is applicable to broad fields. For example, for the purpose of mainly enhancing weather resistance, the infrared shielding film is used as a film for being attached to windows, and a film for agricultural vinyl greenhouses in such a manner that the film is pasted on facilities (substrates) such as outdoor windows of buildings or car windows which are exposed to sunlight for a long time so as to exhibit an infrared shielding effect. In particular, it is preferable that the optical reflection film according to the present invention be pasted directly or via an adhesive onto a glass or a member, in replace of a glass, which is pasted on a substrate such as a resin.

Specific examples of the substrate include a glass, a polycarbonate resin, a polysulfone resin, an acrylic resin, a polyolefin resin, a polyether resin, a polyester resin, a polyamide resin, a polysulfide resin, an unsaturated polyester resin, an epoxy resin, a melamine resin, a phenol resin, a diallyl phthalate resin, a polyimide resin, a urethane resin, a polyvinyl acetate resin, a polyvinyl alcohol resin, a styrene resin, a vinyl chloride resin, a metal plate, and ceramics. The type of resins may be any one of a thermoplastic resin, a thermosetting resin, an ionizing radiation curing resin, and may be used in combination of two or more types. The substrate can be produced by a known method such as extrusion molding, calendar molding, injection molding, hollow molding, or compression molding. The thickness of the substrate is, although not particularly limited, generally 0.1 mm to 5 cm.

When the optical reflection film is pasted on the substrate, it is preferable that an adhesive layer or a pasting layer be disposed such that the optical reflection film is positioned at a sunlight (heat ray) incident side. Further, by sandwiching the optical reflection film between the window glass and the substrate, the optical reflection film can be sealed from environment gas such as moisture. Accordingly, it is preferable from the point of excellent durability. The disposition of the optical reflection film at the outdoor side or the outside (for outdoor pasting) of vehicles is also preferable to enhance the durability against environment.

As an adhesive which is used for pasting the optical reflection film and the substrate, an adhesive including a light curable or thermosetting resin as a main component may be used.

The adhesive is preferable to have durability against ultraviolet rays, and an acrylic-based adhesive or a silicone-based adhesive is preferable. Further, from the viewpoints of adhesion characteristics and cost, an acrylic-based adhesive is preferable. In particular, from the viewpoint of easy control of peel-off strength, as for an acrylic-based adhesive, the solvent-type is preferable. In a case where a solution polymerization polymer is used as an acrylic solvent-type adhesive, a well-known monomer can be used.

Further, as an interlayer of a laminated glass, a polyvinyl butyral resin or an ethylene-vinylacetate copolymer resin may be used. Specific examples include plastic polyvinyl butyral (manufactured by Sekisui Chemical Co., Ltd., and Mitsubishi Monsanto Co., or the like), an ethylene-vinylacetate copolymer (Duramin, manufactured by Du Pont Kabushiki Kaisha, and Takeda Chemical Industries, Ltd.), and a modified ethylene-vinylacetate copolymer (Melsen G, manufactured by TOSOH CORP.). Moreover, into the adhesive layer, an ultraviolet absorbing agent, an anti-oxidant, an antistatic agent, a heat stabilizer, a lubricant, a bulking agent, a coloring agent, an adhesion regulating agent, and the like may be suitably added and blended.

The heat insulating performance and solar heat shielding performance of an optical reflection film or an optical reflection body can be generally obtained by methods based on JIS R3209-1998 (double-layer glass), JIS R3106-1998 (Testing method on transmittance, reflectance and emittance of flat glasses and evaluation of solar heat gain coefficient), and JIS R3107-1998 (evaluation on thermal resistance of flat glasses and thermal transmittance of glazing).

With regard to the measurement of solar transmittance, solar reflectance, emissivity, and visible light transmittance, (1) spectrophotometric transmittance and spectrophotometric reflectance of various single flat glasses are measured using a spectrophotometric light measuring device (a wavelength of 300 to 2500 nm). Further, by using a spectrophotometric light measuring device with a wavelength of 5.5 to 50 μm, the emissivity is measured. Meanwhile, as for the emissivity of a float plate glass, a polished plate glass, a template plate glass, and a heat ray-absorbing plate glass, previously determined values are used. (2) With regard to calculation of solar transmittance, solar reflectance, solar absorbance and corrected emissivity, solar transmittance, solar reflectance, solar absorbance, and normal emissivity are calculated according to JIS R3106-1998. The corrected emissivity is obtained by multiplying the normal emissivity by a coefficient described in JIS R3107-1998. For calculation of the heat insulating property and solar heat shielding property, (1) thermal resistance of a sealed insulating glass is calculated according to JIS R3209-1998 by using the measured thickness value and corrected emissivity. However, when a hollow layer is more than 2 mm, the gas heat conductance of the hollow layer is obtained according to JIS R3107-1998. (2) The heat insulating property is obtained as heat transmission resistance by adding the heat transfer resistance to the thermal resistance of the sealed insulating glass. (3) The solar heat shielding property is calculated by obtaining a solar heat gain coefficient according to JIS R3106-1998 and subtracting the result from 1.

### Examples

Hereinafter, the present invention will be described in detail on the basis of Examples, but the present invention is not limited to these Examples. Meanwhile, the expression of “part” or “%” referred to in Examples represents “parts by weight” or “% by weight”, unless otherwise specified.

Meanwhile, unless specifically described otherwise, measurement of physical properties or the like is made at room temperature (20 to 25° C.)/relative humidity of 40 to 50%.

(Production of Silica Microparticle a Adsorbed with Silanol-Modified Polyvinyl Alcohol)

80 parts by mass of 10% by mass aqueous solution of colloidal silica (particle diameter (volume average) of 4 to 6 nm, SNOWTEX OXS manufactured by Nissan Chemical Industries, Ltd.) were heated to 30° C. under stirring and then added with 15 parts by mass of 4.0% by mass aqueous solution of silanol-modified polyvinyl alcohol (PVA-R1130, manufactured by KURARAY Co., Ltd.) and 5 parts by mass of pure water. After that, the liquid was stirred for 3 hours while being maintained at a temperature of 30° C. and then cooled to 25° C. The resultant was used as a liquid of the silica microparticle A.

As a result of measuring the particle diameter of the silica microparticle A in the liquid by using Zetasizer Nano-S (manufactured by Malvern Instruments Ltd.), the volume average particle diameter was found to be 15 nm.

(Production of Silica Microparticle B Adsorbed with Silanol-Modified Polyvinyl Alcohol)

A liquid of the silica microparticle B was produced in the same manner as the silica microparticle A except that the heating temperature was changed from 30° C. to 40° C.

As a result of measuring the particle diameter of the silica microparticle B in the liquid by using Zetasizer Nano-S (manufactured by Malvern Instruments Ltd.), the volume average particle diameter was found to be 50 nm.

(Production of Silica Microparticle C Adsorbed with Silanol-Modified Polyvinyl Alcohol)

A liquid of the silica microparticle C was produced in the same manner as the silica microparticle A except that the heating temperature is changed from 30° C. to 50° C. and the stirring was performed for 2 hours while maintaining the liquid at the temperature of 50° C. followed by cooling to 25° C.

As a result of measuring the particle diameter of the silica microparticle C in the liquid by using Zetasizer Nano-S (manufactured by Malvern Instruments Ltd.), the volume average particle diameter was found to be 80 nm.

(Production of Silica Microparticle D Adsorbed with Silanol-Modified Polyvinyl Alcohol)

A liquid of the silica microparticle D was produced in the same manner as the silica microparticle A except that the heating temperature is changed from 30° C. to 50° C.

As a result of measuring the particle diameter of the silica microparticle D in the liquid by using Zetasizer Nano-S (manufactured by Malvern Instruments Ltd.), the volume average particle diameter was found to be 100 nm.

(Production of Silica Microparticle E Adsorbed with Non-Modified Polyvinyl Alcohol)

A liquid of the silica microparticle E was produced in the same manner as the silica microparticle D except that polyvinyl alcohol (PVA103, manufactured by KURARAY Co., Ltd.) was used instead of PVA-R1130.

As a result of measuring the particle diameter of the silica microparticle E in the liquid by using Zetasizer Nano-S (manufactured by Malvern Instruments Ltd.), the volume average particle diameter was found to be 10 nm.

(Preparation of Coating Liquid L1 for Low Refractive Index Layer)

To the liquid of the silica microparticle A (68 parts by mass) which has been heated to 40° C., 20 parts by mass of 3% by mass aqueous solution of boric acid were added under stirring. Then, 280 parts by mass of 5% by mass aqueous solution of polyvinyl alcohol (PVA235, weight average molecular weight of 150,000, manufactured by KURARAY Co., Ltd.) and 240 parts by mass of pure water were added. After stirring for 10 minutes, 0.64 part by mass of 5% by mass aqueous solution of a surfactant (Softazoline LSB-R, manufactured by Kawaken Fine Chemicals Co., Ltd.) was added to prepare the coating liquid L1 for low refractive index layer.

(Preparation of Coating Liquid L2 for Low Refractive Index Layer)

To the liquid of the silica microparticle B (68 parts by mass) which has been heated to 40° C., 20 parts by mass of 3% by mass aqueous solution of boric acid were added under stirring. Then, 280 parts by mass of 5% by mass aqueous solution of polyvinyl alcohol (PVA235, weight average molecular weight of 150,000, manufactured by KURARAY Co., Ltd.) and 240 parts by mass of pure water were added. After stirring for 10 minutes, 0.64 part by mass of 5% by mass aqueous solution of a surfactant (Softazoline LSB-R, manufactured by Kawaken Fine Chemicals Co., Ltd.) was added to prepare the coating liquid L2 for low refractive index layer.

(Preparation of Coating Liquid L3 for Low Refractive Index Layer)

To the liquid of the silica microparticle C (68 parts by mass) which has been heated to 40° C., 20 parts by mass of 3% by mass aqueous solution of boric acid were added under stirring. Then, 280 parts by mass of 5% by mass aqueous solution of polyvinyl alcohol (PVA235, weight average molecular weight of 150,000, manufactured by KURARAY Co., Ltd.) and 240 parts by mass of pure water were added. After stirring for 10 minutes, 0.64 part by mass of 5% by mass aqueous solution of a surfactant (Softazoline LSB-R, manufactured by Kawaken Fine Chemicals Co., Ltd.) was added to prepare the coating liquid L3 for low refractive index layer.

(Preparation of Coating Liquid L4 for Low Refractive Index Layer)

To the liquid of the silica microparticle D (68 parts by mass) which has been heated to 40° C., 20 parts by mass of 3% by mass aqueous solution of boric acid were added under stirring. Then, 280 parts by mass of 5% by mass aqueous solution of polyvinyl alcohol (PVA235, weight average molecular weight of 150,000, manufactured by KURARAY Co., Ltd.) and 240 parts by mass of pure water were added. After stirring for 10 minutes, 0.64 part by mass of 5% by mass aqueous solution of a surfactant (Softazoline LSB-R, manufactured by Kawaken Fine Chemicals Co., Ltd.) was added to prepare the coating liquid L4 for low refractive index layer.

(Preparation of Coating Liquid L5 for Low Refractive Index Layer)

To the liquid of the silica microparticle E (68 parts by mass) which has been heated to 40° C., 20 parts by mass of 3% by mass aqueous solution of boric acid were added under stirring. Then, 280 parts by mass of 5% by mass aqueous solution of polyvinyl alcohol (PVA235, weight average molecular weight of 150,000, manufactured by KURARAY Co., Ltd.) and 240 parts by mass of pure water were added. After stirring for 10 minutes, 0.64 part by mass of 5% by mass aqueous solution of a surfactant (Softazoline LSB-R, manufactured by Kawaken Fine Chemicals Co., Ltd.) was added to prepare the coating liquid L5 for low refractive index layer.

(Preparation of Coating Liquid L6 for Low Refractive Index Layer)

To colloidal silica (60 parts by mass, SNOWTEX OXS, manufactured by Nissan Chemical Industries, Ltd.) which has been heated to 40° C., 20 parts by mass of 3% by mass aqueous solution of boric acid were added under stirring. Then, 280 parts by mass of 5% by mass aqueous solution of polyvinyl alcohol (PVA235, weight average molecular weight of 150,000, manufactured by KURARAY Co., Ltd.) and 240 parts by mass of pure water were added. After stirring for 10 minutes, 0.64 part by mass of 5% by mass aqueous solution of a surfactant (Softazoline LSB-R, manufactured by Kawaken Fine Chemicals Co., Ltd.) was added to prepare the coating liquid L6 for low refractive index layer.

(Preparation of Coating Liquid H1 for High Refractive Index Layer)

10 L of an aqueous suspension in which titanium dioxide hydrate is suspended in water (concentration of TiO₂ is 100 g/L) was added with 30 L of an aqueous solution of sodium hydroxide (concentration of 10 mol/L) under stirring. It was then heated to 90° C. and aged for five hours. Subsequently, the resultant solution was neutralized with hydrochloric acid, filtered and then washed. Meanwhile, for the aforementioned reaction (treatment), the titanium dioxide hydrate is used as the one which has been obtained by thermal hydrolysis of an aqueous solution of titanium sulfate according to a known method.

The base-treated titanium compound was suspended in pure water so as to have the TiO₂ concentration of 20 g/L. 0.4% by mol of citric acid with respect to the amount of TiO₂ was added thereto under stirring followed by the temperature increase. Then, when the temperature of the liquid becomes 95° C., concentrated hydrochloric acid was added thereto so as to have the hydrochloric acid concentration of 30 g/L, followed by stirring for three hours while maintaining the temperature of the solution.

The obtained aqueous dispersion of titanium oxide sol was subjected to measurement of pH and zeta potential. As a result, the pH thereof was 1.4 and the zeta potential thereof was +40 mV. Further, a particle diameter measurement was performed by Zetasizer Nano manufactured by Malvern Instruments Ltd. As a result, it was found that the volume average particle diameter is 35 nm and a degree of monodispersity is 16%.

Further, 1 kg of pure water was added to 1 kg of 20.0% by mass of aqueous dispersion of titanium oxide sol containing rutile-type titanium oxide particles with the volume average particle diameter of 35 nm.

Preparation of Aqueous Silicic Acid Solution

An aqueous silicic acid solution with the SiO₂ concentration of 2.0% by mass was prepared.

Preparation of Silica Modified Titanium Oxide Particles

To 0.5 kg of 10.0% by mass aqueous dispersion of titanium oxide sol described above, 2 kg of pure water was added and heated to 90° C. Subsequently, 1.3 kg of 2.0% by mass aqueous silicic acid solution was gradually added thereto and the resulting dispersion was subjected to a heating treatment at 175° C. for 18 hours in an autoclave for further concentration. As a result, a sol dispersion of 20% by mass silica-modified titanium oxide particles in which titanium oxide having a rutile-type structure has SiO₂ as a coating layer was obtained.

By adding at 45° C. the following materials in order from the top, a coating liquid was prepared.

Aqueous sol dispersion of silica-modified titanium oxide particles (20.0% by mass) 320 parts

Aqueous solution of citric acid (1.92% by mass) 120 parts

Polyvinyl alcohol (10% by mass) 20 parts

(PVA103, polymerization degree of 300, saponification degree of 99% by mol, manufactured by KURARAY Co., Ltd.)

Aqueous solution of boric acid (3% by mass) 100 parts

Polyvinyl alcohol (4% by mass) 350 parts

(manufactured by KURARAY Co., Ltd., PVA-124, polymerization degree of 2400, saponification degree of 88% by mol)

Surfactant (5% by mass) 1 part

(Softazoline LSB-R, manufactured by Kawaken Fine Chemicals Co., Ltd.)

By finishing with 1000 parts with pure water, coating liquid H1 for high refractive index layer was prepared.

(Preparation of Coating Liquid H2 for High Refractive Index Layer)

Coating liquid H2 for high refractive index layer was produced in the same manner as the preparation of coating liquid H1 for high refractive index layer except that zirconia sol (NanoUse ZR30-AR, manufactured by Nissan Chemical Industries, Ltd.) was used instead of the silica-modified titanium oxide particles.

(Preparation of Coating Liquid H3 for High Refractive Index Layer)

Coating liquid H3 for high refractive index layer was prepared in the same manner as coating liquid H1 for high refractive index layer except that 4% by mass of aqueous solution of methyl cellulose (METOLOSE SM25, manufactured by Shin-Etsu Chemical Co., Ltd.) was used instead of an aqueous solution of polyvinyl alcohol (manufactured by KURARAY Co., Ltd., PVA-124, polymerization degree of 2400, saponification degree of 88% by mol).

(Production of Sample 1)

By using a slide hopper coating apparatus which can be used for 9-layer multilayer coating and maintaining the temperatures of the coating liquid L1 for a low refractive index layer and the coating liquid H1 for a high refractive index layer obtained from above at 45° C., total nine layers were formed by simultaneous multilayer coating on a polyethylene terephthalate film with a thickness of 50 μm (A4300 manufactured by Toyobo Co., Ltd.; easy adhesion layer on both surfaces), which has been heated to 45° C., such that the lowermost layer and the uppermost layer are a low refractive index layer while other layers are laminated alternately, and the thickness of each low refractive index layer is 150 nm and the thickness of each high refractive index layer is 130 nm at the time of drying.

Immediately after the coating, setting was performed by blowing cool air at 5° C.

When the setting was completed, hot air at 80° C. was blown for drying, and thus a multilayer coated product was prepared.

On the back surface of the aforementioned 9-layer multilayer coated product (a substrate surface (back surface) opposite to the substrate surface coated with 9-layer multilayer), 9-layer multilayer coating was additionally performed.

Furthermore, on top of the reflection layer obtained from above (one side surface), 10.0% by mass ethanol solution of a polyvinyl acetal resin (BX-L, acetalization degree of 61% by mol, manufactured by Sekisui Chemical Company, Limited) was coated such that the dried film thickness was 1 μm. Thus, infrared shielding film sample 1 was prepared.

(Preparation of Samples 2 to 9)

Samples 2 to 9 were prepared in the same manner as the preparation of Sample 1 except that each of the coating liquid for a low refractive index layer and the coating liquid for a high refractive index layer was changed to those described in Table 1.

(Evaluation)

<Measurement of Visible Light Transmittance and Near-Infrared Transmittance>

By using the above spectrophotometer (an integrating sphere was used, manufactured by Hitachi, Ltd., U-4000), the transmittance of each near-infrared reflection film was measured in the region of 300 nm to 2000 nm. The transmittance at 550 nm was used as visible light transmittance, and the transmittance at 1200 nm was used as near-infrared transmittance.

<Haze Value>

The haze value was measured for Samples 1 to 9 by using a haze meter (manufactured by NIPPON DENSHOKU INDUSTRIES Co., LTD., NDH2000) and the evaluation was made as follows.

1% or less ⊙

More than 1% and 1.5% or less ◯

More than 1.5% and 2% or less Δ

More than 2% X

<Coating Stripes>

Defects of coating stripes present on coated surface of sample were visually evaluated as described below for a part with a coating width of 1.8 m and a coating length of 1 m of Samples 1 to 9 which were prepared from above.

5. No occurrence of coating stripes.

4. Several weak coating stripes on side.

3. Several weak coating stripes also in the vicinity of center area of coating film.

2. Strong coating stripes in some parts.

1. Strong coating stripes found on the entire surface of coating film.

<Dotted Defects>

Dotted defects present on coated surface of sample were visually evaluated as described below for apart with a coating width of 1.8 m and a coating length of 1 m of Samples 1 to 9 which were prepared from above.

5. No occurrence of dotted defects.

4. Several weak dotted defects on side.

3. Several weak dotted defects found on the entire surface of coating film.

2. Several dotted defects that are clearly identifiable by a naked eye.

1. Many dotted defects that are clearly identifiable by a naked eye are found on the entire surface of coating film.

The results are shown below.

TABLE 1

| | | Low | High | | | | | |
|---|---|---|---|---|---|---|---|---|
| | | refractive | refractive | Visible light | Infrared | | | |
| | | index | index | transmittance | transmittance | | Coating | Dotted |
| | Sample | layer | layer | ( % ) | (% ) | Haze | stripes | defects |
| Present | 1 | Ll | H1 | 78 | 12 | ◯ | 4 | 4 |
| invention | | | | | | | | |
| Present | 2 | L2 | H1 | 80 | 10 | ⊙ | 5 | 5 |
| invention | | | | | | | | |
| Present | 3 | L2 | H2 | 80 | 14 | ⊙ | 5 | 5 |
| invention | | | | | | | | |
| Present | 4 | L2 | H3 | 78 | 13 | ⊙ | 5 | 4 |
| invention | | | | | | | | |
| Present | 5 | L3 | H1 | 78 | 10 | ⊙ | 5 | 5 |
| invention | | | | | | | | |
| Present | 6 | L3 | H3 | 78 | 12 | ◯ | 4 | 4 |
| invention | | | | | | | | |
| Present | 7 | L4 | H3 | 75 | 12 | ◯ | 4 | 4 |
| invention | | | | | | | | |
| Comparative | 8 | L5 | H1 | 75 | 18 | Δ | 1 | 2 |
| Example | | | | | | | | |
| Comparative | 9 | L6 | H1 | 79 | 16 | Δ | 2 | 1 |
| Example | | | | | | | | |

As it can be recognized from the above, Samples 1 to 7 have low infrared transmittance and low haze value, and thus have favorable film properties. Furthermore, by having less coating stripes or dotted defects, the Samples 1 to 7 have a favorable coating property.

The present application is based on Japanese Patent Application No. 2012-242593 filed on Nov. 2, 2012, and its disclosure is incorporated herein by reference in its entirety.

1. An optical reflection film comprising a base and, formed thereon, at least one unit obtained by laminating a high refractive index layer and a low refractive index layer,
wherein the low refractive index layer comprises silica particles onto which a silanol-modified polyvinyl alcohol has been adsorbed.

2. The optical reflection film according to claim 1, wherein the silica particles adsorbed with silanol-modified polyvinyl alcohol are obtained by mixing aqueous silica sol and a solution of silanol-modified polyvinyl alcohol followed by a heating treatment.

3. The optical reflection film according to claim 1, wherein an average particle diameter of the silica particles adsorbed with silanol-modified polyvinyl alcohol is 20 nm or more and 80 nm or less.

4. The optical reflection film according to claim 1, wherein the low refractive index layer comprises a water soluble polymer.

5. The optical reflection film according to claim 1, wherein the high refractive index layer comprises metal oxide particles.

6. The optical reflection film according to claim 5, wherein the metal oxide particles comprise at least one of titanium oxide and zirconium oxide.

7. The optical reflection film according to claim 1, the optical reflection film being an infrared shielding film.

8. A method for producing an optical reflection film, the method comprising:
a step of producing a coating liquid for a low refractive index layer in which silica particles adsorbed with silanol-modified polyvinyl alcohol are contained;
a step of producing a coating liquid for a high refractive index layer in which metal oxide particles are contained; and
a step of alternately laminating on a substrate the coating liquid for a low refractive index layer and the coating liquid for a high refractive index layer by simultaneous multilayer coating.

9. The method for producing an optical reflection film according to claim 8, wherein the step of producing a coating liquid for a low refractive index layer includes:
a step (A) in which aqueous silica sol and a solution of silanol-modified polyvinyl alcohol are admixed with each other and heated to obtain silica particles adsorbed with silanol-modified polyvinyl alcohol; and
a step (B) in which a water soluble polymer is added after the step (A).

10. The optical reflection film according to claim 2, wherein an average particle diameter of the silica particles adsorbed with silanol-modified polyvinyl alcohol is 20 nm or more and 80 nm or less.

11. The optical reflection film according to claim 2, wherein the low refractive index layer comprises a water soluble polymer.

12. The optical reflection film according to claim 2, wherein the high refractive index layer comprises metal oxide particles.

13. The optical reflection film according to claim 2, the optical reflection film being an infrared shielding film.

14. The optical reflection film according to claim 3, wherein the low refractive index layer comprises a water soluble polymer.

15. The optical reflection film according to claim 3, wherein the high refractive index layer comprises metal oxide particles.

16. The optical reflection film according to claim 3, the optical reflection film being an infrared shielding film.

17. The optical reflection film according to claim 4, wherein the high refractive index layer comprises metal oxide particles.

18. The optical reflection film according to claim 4, the optical reflection film being an infrared shielding film.

19. The optical reflection film according to claim 5, the optical reflection film being an infrared shielding film.

20. The optical reflection film according to claim 6, the optical reflection film being an infrared shielding film.
